(19) United States
(12) Patent Application Publication
(10) Pub. No.: US 2016/0328636 A1
(43) Pub. Date: Nov. 10, 2016

(54) DEVICE FOR TRANSFORMING AN ELECTROMAGNETIC FIELD

(71) Applicant: GEMALTO SA, Meudon (FR)

(72) Inventors: Francois-Xavier MARSEILLE, Meudon (FR); Michel THILL, Meudon (FR)

(73) Assignee: GEMALTO SA, Meudon (FR)

(21) Appl. No.: 15/109,388

(22) PCT Filed: Dec. 2, 2014
(86) PCT No.: PCT/EP2014/076170

§ 371 Date: Jun. 30, 2016

(30) Foreign Application Priority Data
Dec. 30, 2013 (EP) 13306893.2

(51) Int. Cl. G06K 19/06

(52) U.S. Cl. CPC G06K 19/06206

(57) ABSTRACT

The invention relates to a magnetic field transformation device comprising a battery, a processing unit, an antenna coupled with the processing unit and capable of exchanging data according to the standard ISO14443, a coil coupled with the processing unit and capable of radiating a low-frequency electromagnetic field corresponding to a succession of bits emulating the passing of a magnetic stripe.

The invention relates to an electromagnetic field transformer.

Bank card payment terminals are made of terminals that can exchange payment information with bank cards. A first mode of information exchange is taking the physical imprint of the card using an inkpad to collect the information embossed on the card, which makes it possible to identify the card holder and the bank account. This first mode of information exchange is now almost obsolete, as it does not make it possible to verify if the card is stolen and further makes it relatively easy to copy an actual transaction. A second mode of information exchange is the reading of a magnetic stripe on which the identifier of the card and the account are saved on the magnetic stripe located on the back of the card. That second mode of information exchange allows the reader to communicate with a remote server to verify the validity of the card. It is currently the most widespread transaction mode in the world, which further acts as a backup for more secure information exchange systems when these are not compatible or are faulty.

A third mode of information exchange is by means of a surface connector connected to a microchip. Conventionally, this type of system is compatible with the standard ISO7816 and allows different payment techniques offering security similar to magnetic stripe payment (simple exchange of information) to a much higher security level that requires PIN entry by the user and also the exchange of encrypted messages between the microchip and a remote server of a banking institution. That third mode is mostly deployed in Europe. A fourth mode of information exchange is by near field contactless (or NFC communication) as defined in the standard ISO14443. For reasons relating to conciseness, in the description below, the acronym NFC will be used as a synonym of near field contactless communication compatible with the standard ISO14443. The fourth mode of exchange uses an antenna coupled with a microchip that is powered by the electromagnetic field that is used to exchange information between the card and the reader. That fourth mode allows for as many securing possibilities as the third mode and it further allows the dematerialisation of the payment card by integrating it in a mobile telephone, for example.

Smart cards used for payment can always carry out a transaction by means of the magnetic stripe. That makes it possible to authorise transactions in countries or places where readers do not support smart cards. A problem occurs when a telephone is used as a replacement for one's bank card. Indeed, while it is possible to pay using NFC with a telephone, the telephone does not have a magnetic stripe that can be read by a payment terminal. The use of the telephone as a substitute for a bank card is thus limited to NFC payment points.

In order to remedy that drawback, the use of magnetic stripe emulators for smart mobile telephones is known. A program downloaded in the telephone translates the code of the magnetic stripe into an analogue/digital signal that is sent to an external amplifier and a coil that translates the analogue/digital signal into electromagnetic radiation corresponding to a succession of bits that are normally saved on the magnetic stripe of a card. The coil is brought close to a magnetic stripe reader before the triggering of the sending of the succession of bits, thus emulating a pass of a magnetic stripe. The main problem with this mode of payment is that the payment information is processed by the processing means of the telephone and thus in an open environment that may be hacked, and the information allowing the payment may be stolen with malicious software.

For its part, NFC payment is normally executed in a secure environment such as the SIM card, an SD card with a secure microchip or a secure component of the telephone independent from the other processing means of the telephone. The secure environment has a direct communication link with an antenna that allows the NFC link.

The invention is aimed at allowing a payment device such as a mobile telephone to make payment by emulating a magnetic stripe with maximum data security. In order to keep NFC secure, the invention provides a device that makes it possible to transform an NFC message into a magnetic stripe emulation.

More particularly, the invention is a magnetic field transformation device comprising an independent battery, a processing unit, an antenna coupled with the processing unit and capable of exchanging data according to the standard ISO14443, a coil coupled with the processing unit and capable of radiating a low-frequency electromagnetic field corresponding to a succession of bits emulating a magnetic stripe pass.

Preferably, the processing unit has a volatile memory, wherein said volatile memory is used to store all the information received from the antenna and emitted via the coil.

Equally, the invention relates to a payment method using a mobile telephone on a magnetic stripe payment terminal using an intermediate device. First of all, the telephone provides the intermediate device with the information required for a payment transaction by means of an exchange protocol that complies with standard ISO14443. Then, the intermediate device transforms said information into a succession of bits corresponding to bits saved on a bank card magnetic stripe. Lastly, the intermediate device emits a magnetic field modulated by the succession of bits near a magnetic stripe reader.

The device according to the invention makes it possible to keep in the secure microchip of the telephone all the bank information that is sent via the NFC antenna, possibly encrypted, to a magnetic stripe emulation device that is not connected, and thus difficult to hack.

The invention will be better understood and other advantages will appear in the description below, which refers to the attached drawings, where:

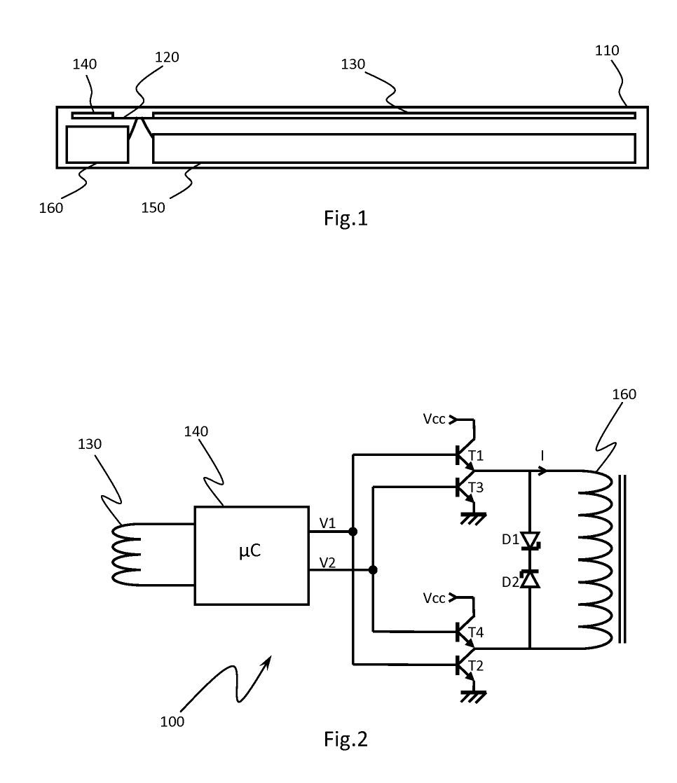

FIG. 1 is a structural representation of a longitudinal section of the invention,

FIG. 2 is a simplified electrical diagram of the invention,

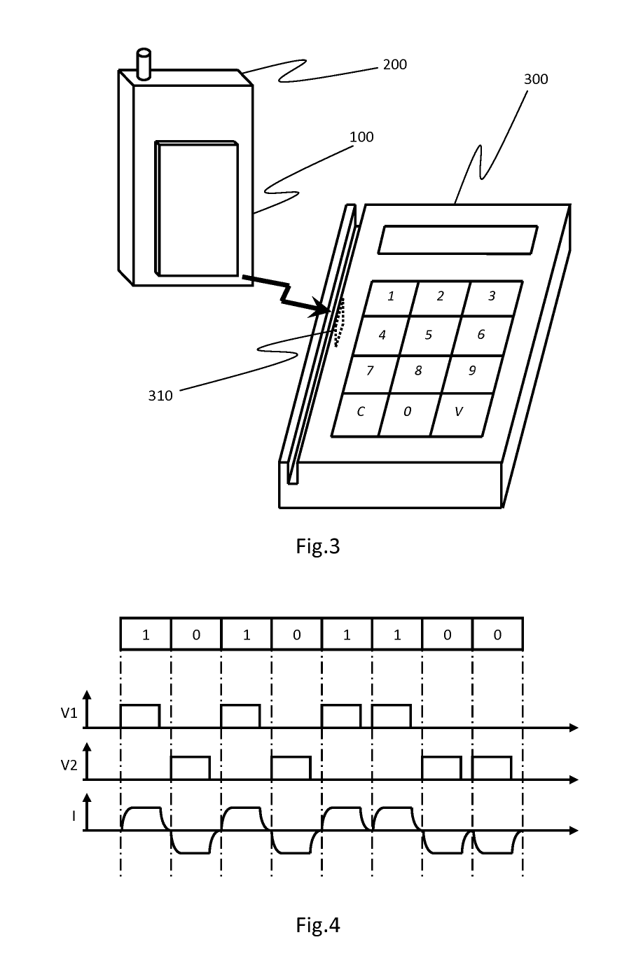

FIG. 3 represents a use of the invention, and

FIG. 4 illustrates the transformation of a string of bits into current producing a magnetic stripe emulation field.

FIGS. 1 and 2 show a device 100 for transforming electromagnetic fields according to the invention. FIG. 1 shows a longitudinal section of the device 100 and FIG. 2 shows a simplified electrical diagram. A housing 110 encloses a printed circuit 120 supporting an antenna 130 and a processing unit 140. A battery 150 and a coil 160 are placed in the housing 110 and connected to a printed circuit 120 by means of connecting wires. The battery 150 is used to power the components of the device 100.

The processing unit 140 is for example made with the help of a microcontroller including a microprocessor, the memory, an NFC interface and at least two digital outputs. The NFC interface is connected to the antenna 130 in order to be able to communicate with an NFC reader compatible with the standard ISO14443. The memory is a composite memory comprising volatile memory and non-volatile memory. The non-volatile memory is essentially used to store the programs implemented by the microprocessor to carry out the transformation of an NFC message into magnetic stripe emulation.

The digital outputs of the processing circuit 140 control two pairs of transistors T1 to T4 that make it possible to switch the current flowing in the coil 160. Thus, the processing unit 140 is connected to the coil 160 to control the emission of a magnetic field emulating a magnetic stripe pass before a magnetic stripe reader sensor. The first pair of transistors T1 and T2 makes it possible to make a positive current I flow in the coil 160 when their bases receive positive voltage. The second pair of transistors T3 and T4 makes it possible to make a negative current I flow in the coil 160 when their bases receive positive voltage. Thus, one pair is to be activated when a bit is ‘zero’ and the other when a bit is ‘one’. Of course, care must be taken to make sure that only one pair of transistors is conducting. Preferably, a pair is only activated if the other pair is not activated. A pair of diodes D1 and D2 are connected in series and inversely in parallel on coil 160. These two diodes D1 and D2 are avalanche diodes or Zener diodes with reverse breakdown voltages greater than the power supply voltage so as to cut off voltage surges created by coil switching.

FIG. 3 illustrates the use of the device 100 for transforming the electromagnetic field. The device 100 is placed on a mobile telephone 200. The device 100 is placed on the telephone as close as possible to the NFC antenna of the telephone 200. The device 100 may be held on the telephone 200 by the user or by any holding means such as adhesive, an elastic band or a shell adapted to the telephone that holds the device on the telephone temporarily or permanently.

During payment in a store, the telephone 200 must be brought close to the payment terminal 300 while holding the device 100 on the telephone. Ideally, the part of the device 100 where the coil 160 is located is placed as close as possible to the sensor 310 that reads a magnetic stripe. When the condition of proximity is fulfilled, the user can trigger the payment operation by pressing a key on the telephone 200 or its touch screen.

When the payment operation is triggered, the telephone puts its NFC interface in reader mode. The emission of the field is captured by the antenna 130, which wakes up the processing unit 140. After mutual authentication of the telephone 200 and the device 100, the telephone 200 provides the device 100 with a code corresponding to the information for identifying a bank account. That information is provided via the NFC interface of the telephone 200, and thus under the control of a secure circuit of the telephone. For the telephone 200, the payment operation has the same level of security as an NFC payment with low security, but the data do not go through the central operating system of the telephone.

The processing unit 140 saves the code received in its volatile memory so that no data are saved in the device after the transaction is completed. The code is then transformed into a series of bits corresponding to those that would be written on the magnetic stripe of a bank card. The series of bits is then transformed into control signals so that ‘zero’ is a current I flowing in one direction and ‘one’ is a current I flowing in the other direction. The speed of the control signals is a frequency corresponding to the passing of a card in the reader so that the coil 160 emits a magnetic field modulated by a succession of bits with a reverse field between ‘one’ and ‘zero’.

FIG. 4 illustrates the transformation of a series of bits into control signals V1 and V2 then into current I. As can be seen, the control signals V1 and V2 are never active at the same time. The resulting current I is proportional with the intensity of the magnetic field produced by the coil 160, and so the sensor 310 receives a magnetic field with an intensity proportional with the current I with a reversal of the field between zeroes and ones.

In the example described, the battery 150 is only used to supply the voltage VCC, and the processing unit 140 is powered by the NFC field. However, it may be of use to add a switch to the device to limit the leakage currents and increase the life of the battery. Also, a switch on the antenna 130 may be of use if the field transformation device remains integral with the telephone. The opening of the antenna thus decouples it and it is not a source of interference for other NFC applications of the telephone in which the device is not involved.

In one alternative, the battery is a rechargeable battery that is recharged by capturing part of the NFC field of the telephone when the telephone is active.

1. A device for transforming an electromagnetic field comprising: an independent battery,
a processing unit,
an antenna coupled with the processing unit and capable of exchanging data according to the standard IS014443,
a coil coupled with the processing unit and capable of radiating a low-frequency electromagnetic field corresponding to a succession of bits emulating the passing of a magnetic stripe.

2. The device according to claim 1, wherein the processing unit has a volatile memory, wherein said volatile memory is used to store all the information received from the antenna and emitted via the coil.

3. The device according to claim 1, wherein the processing unit is connected to the coil to control the emission of a magnetic field emulating the passing of a magnetic stripe.

4. The device according to claim 1, wherein the battery is a rechargeable battery that is recharged on a magnetic field compatible with the standard ISO 14443.

5. A payment method using a mobile telephone on a terminal for payment by magnetic stripe with the help of an intermediate device comprising:
supplying by the telephone to the intermediate device of the information required for a payment transaction by means of an exchange protocol that complies with standard ISO14443,
transforming, by the intermediate device, said information into a succession of bits corresponding to bits saved on a bank card magnetic stripe,
emitting, by the intermediate device, a magnetic field modulated by the succession of bits near a magnetic stripe reader.
